(19) United States
(12) Patent Application Publication
(10) Pub. No.: US 2026/0005511 A1
(43) Pub. Date: Jan. 1, 2026

(54) SEMICONDUCTOR SWITCH DEVICE, POWER DISTRIBUTION DEVICE, AND POWER SHORT DETECTION METHOD

(71) Applicant: SANKEN ELECTRIC CO., LTD., Niiza-Shi (JP)

(72) Inventor: Shohei OSAKA, Niiza-Shi (JP)

(73) Assignee: SANKEN ELECTRIC CO., LTD., Niiza-Shi (JP)

(21) Appl. No.: 19/234,331

(22) Filed: Jun. 11, 2025

(30) Foreign Application Priority Data
Jul. 1, 2024 (JP) 2024-106058

(51) Int. Cl. H02H 3/28; H02H 1/00; H02H 3/04

(52) U.S. Cl. CPC H02H 3/28; H02H 1/003; H02H 3/04

(57) ABSTRACT

A semiconductor switch device according to one or more embodiments may include a main switch that switches power supplied from a power supply, a driver that outputs a voltage lower than that of normal operation so that the main switch is in a constant voltage regulation state in case of a power short detection operation, a controller that controls a normal operation or a power short detection operation of the driver, a power short detector that detects if an output voltage has a sufficient potential difference with respect to a power supply voltage in the case of the power short detection operation, and a diagnostic circuit that diagnoses the power short and outputs a diagnostic result in response to detecting that the output voltage does not have a sufficient potential difference with respect to the power supply voltage in the case of the power short detection operation of the driver.

### CROSS REFERENCE TO RELATED APPLICATIONS

This application claims priority to prior Japanese Patent Application No. 2024-106058 filed with the Japan Patent Office on Jul. 1, 2024, the entire contents of which are incorporated herein by reference.

### BACKGROUND

The disclosure relates to a semiconductor switch device, a power distribution device, and a power short detection method.

In a related art, a technique is proposed related to a semiconductor switch device that cuts off the power supply and performs a protective operation when an abnormality occurs between a power supply and a load device using power supplied from the power supply via a wiring harness. The Japanese patent application publication JP2015-115692 (patent document 1) discloses a semiconductor abnormality detection circuit including a semiconductor switch circuit and a circuit with a current sensing. The semiconductor abnormality detection circuit disclosed in the patent document 1 identifies whether or not the semiconductor circuit is normally driven based on the on and off voltage levels applied to the control input terminal of the semiconductor switch circuit and the voltage value of the sense signal.

### SUMMARY

A semiconductor switch device that protects a circuit in case of abnormality according to one or more embodiments may include a main switch that switches power supplied from a power supply terminal electrically connected to a power supply to an output terminal electrically connected to a load device, a driver that outputs a voltage lower than that of normal operation to the main switch so that the main switch is in a constant voltage regulation state in case of a power short detection operation of the driver, a controller that controls a normal operation or a power short detection operation of the driver, a power short detector that detects if an output voltage of an output terminal has a sufficient potential difference with respect to a power supply voltage of the power supply terminal in the case of the power short detection operation, and a diagnostic circuit that diagnoses the power short and outputs a diagnostic result in response to detecting that the output voltage does not have a sufficient potential difference with respect to the power supply voltage in the case of the power short detection operation of the driver.

A power distribution device according to one or more embodiments may include a semiconductor switch device including a main switch that switches power supplied from a power supply terminal electrically connected to a power supply to an output terminal electrically connected to a load device, a driver that outputs a voltage lower than that of normal operation to the main switch so that the main switch is in a constant voltage regulation state in a case of a power short detection operation of the driver, a controller that controls a normal operation or a power short detection operation of the driver, a power short detector that detects if an output voltage of an output terminal has a sufficient potential difference with respect to a power supply voltage of the power supply terminal in the case of the power short detection operation, and a diagnostic circuit that diagnoses the power short and outputs a diagnostic result in response to detecting that the output voltage does not have a sufficient potential difference with respect to the power supply voltage in the case of the power short detection operation of the driver, a power supply electrically connected to the power supply terminal of the semiconductor switch device; and a load device electrically connected to the output terminal of the semiconductor switch device.

A power short detection method according to one or more embodiments may include receiving an instruction for a power short detection operation to detect a power short between a power supply terminal and an output terminal in a semiconductor switch device comprising a main switch that switches power supplied from the power supply terminal electrically connected to a power supply to the output terminal electrically connected to a load device, outputting a voltage lower than that of normal operation to the main switch so that the main switch is in a predetermined constant voltage regulation state, detecting whether an output voltage of the output terminal has a sufficient potential difference with respect to a power supply voltage of the power supply terminal, and diagnosing the power short and outputting a diagnostic result in response to detecting that the output voltage does not have a sufficient potential difference with respect to the power supply voltage.

### BRIEF DESCRIPTION OF DRAWINGS

FIG. 1 is a diagram illustrating a power distribution device including a semiconductor switch device according to one or more embodiments.

FIG. 2A is a diagram illustrating an example of processing of a semiconductor switch device according to one or more embodiments.

FIG. 2B is a diagram illustrating an example of processing of a semiconductor switch device according to one or more embodiments.

FIG. 3 is a diagram illustrating to explain a comparative example in power short detection.

FIG. 4 is a diagram illustrating to explain a power short detection according to one or more embodiments.

FIG. 5 is a flowchart illustrating an example of a processing of a power short detection method by a semiconductor switch device according to one or more embodiments.

### DETAILED DESCRIPTION

The semiconductor switch device, the power distribution device, and the power short detection method according to one or more embodiments are described in detail with reference to the drawings. The same or equivalent portions in the diagram of the semiconductor switch device and the power distribution device according to one or more embodiments may be denoted by the same reference numerals.

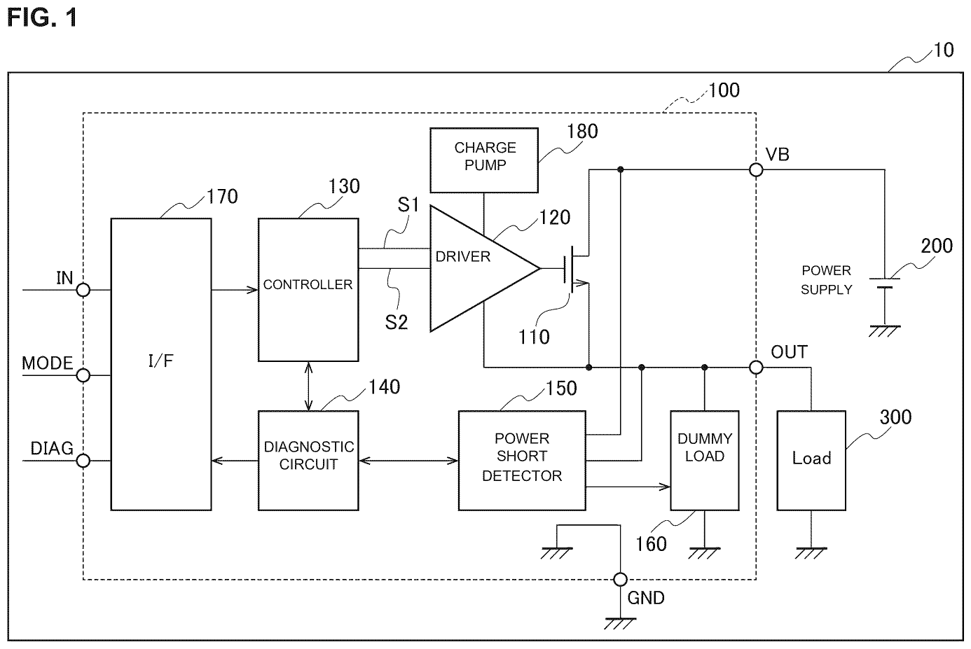

FIG. 1 is a diagram illustrating the power distribution device 10 according to one or more embodiments. The power distribution device 10 may include the semiconductor switch device 100, the power supply 200, and the load device 300. In FIG. 1, the connection state between the internal block of the semiconductor switch device 100 and the power supply 200 and the load device 300 is shown.

The semiconductor switch device 100 is electrically connected to the power supply 200 via a wiring harness from the power supply terminal (VB terminal) that is an input terminal. Further, the semiconductor switch device 100 is electrically connected to the load device 300 via another wiring harness from the output terminal (OUT terminal).

The semiconductor switch device 100 may include the main switch 110, the driver 120, the controller 130, the diagnostic circuit 140, the power short detector 150, the dummy load 160, and the input/output interface 170.

The main switch 110 is a switch that cuts off the power supplied to the load device 300 by turning off at an abnormal state. That is, the main switch 110 controls the on and off of the power supplied from the power supply terminal (VB terminal) electrically connected to the power supply 200 to the output terminal (OUT terminal) electrically connected to the load device 300. In one or more embodiments, the main switch 110 may include, for example, a MOS (Metal-Oxide-Semiconductor) transistor.

The driver 120 is electrically connected to the charge pump 180 and generates a signal to determine whether the main switch 110 is on or off. The controller 130 provides instructions for a normal operation or a power short detection operation to the driver 120. For example, in the case of normal operation, the controller 130 gives an instruction for normal operation to the driver 120 by turning on the control signal S1. Further, in the case of a power short detection operation, the controller 130 gives an instruction to the driver 120 for a power short detection operation by turning on the control signal S2. In one or more embodiments, the power short may include a state in which the terminal, the wiring pattern, and the wiring harness electrically connected to the terminal are shorted (short-circuited) to the power supply. However, it is not limited to this, and widely includes a state in which the wiring is shorted to the power supply.

The diagnostic circuit 140 performs a power short detection process according to instructions from the controller 130, and outputs the diagnostic result to the outside via the input/output interface 170 and the DIAG terminal. The power short detector 150 executes a power short detection process based on instructions from the diagnostic circuit 140 or the controller 130. The dummy load 160 discharges the charge accumulated in the capacitance component present in the load device 300 according to instructions from the power short detector 150. Note that the dummy load 160 may be used as an option that may be set to be used or not depending on the abnormal condition. Further, the dummy load 160 may use a voltage divider resistor that detects an output voltage or an input voltage.

The input/output interface 170 receives control instructions input from the outside via the input terminal and the mode terminal. The input/output interface 170 sends the received control instruction to the controller 130. For example, the control instruction input to the input terminal includes instructions for turning on and off the semiconductor switch device 100. Further, the control instruction input to the mode terminal may be information indicating mode for a normal operation or a power short detection operation. The charge pump 180 may correspond to the power supply supplied to the driver 120. Note that the charge pump 180 supplies a voltage higher than the power supply voltage VB.

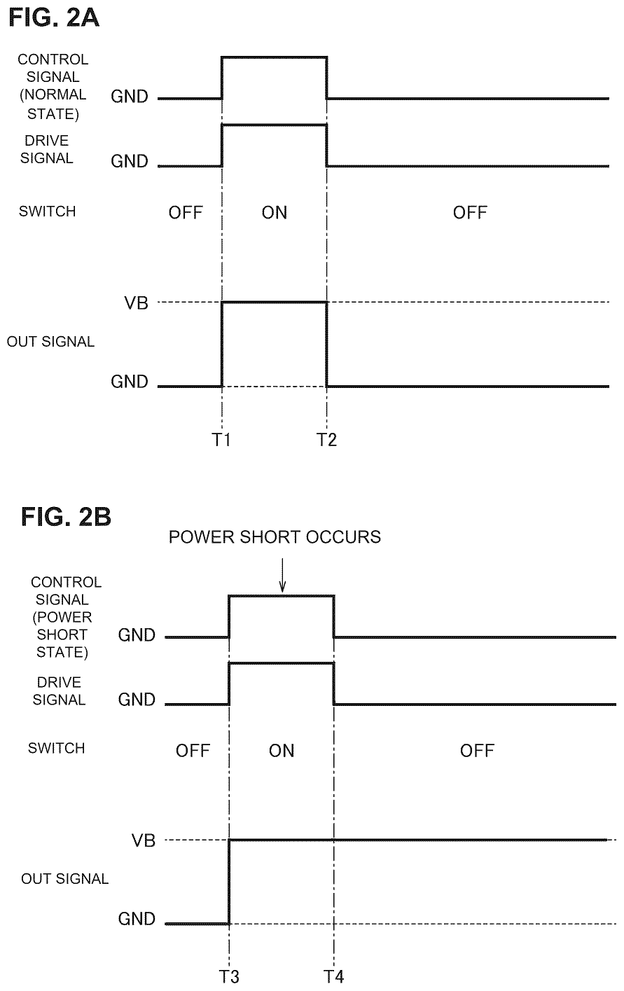

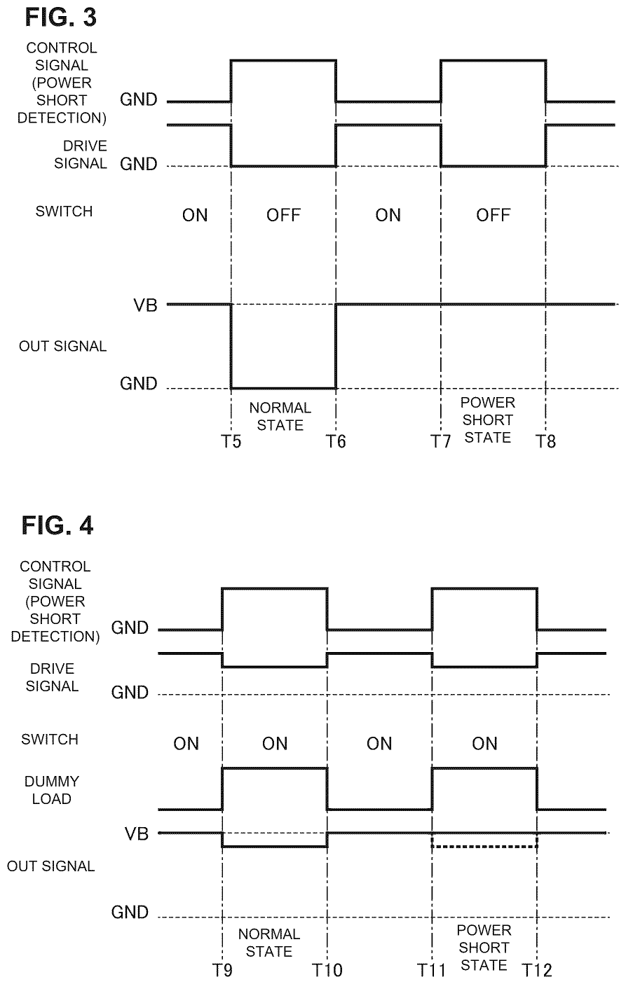

(Normal operation mode) FIG. 2A is a diagram illustrating an example of the processing of the semiconductor switch device 100 according to one or more embodiments, and is a diagram for explaining operation during normal operation. When the control signal from the controller 130 is turned on, the drive signal of the driver 120 is turned on (time T1). As a result, the main switch 110 is turned on, and the output voltage of the output terminal becomes the power supply voltage VB. In FIG. 2A, the “Out signal” indicates the output voltage of the output terminal (OUT terminal) (hereinafter the same applies to FIG. 2B, FIG. 3, and FIG. 4).

Further, when the control signal from the controller 130 is turned off (GND level), the drive signal of the driver 120 is turned off (GND level) (time T2). As a result, the main switch 110 is turned off, the output voltage of the output terminal becomes a GND level voltage, and the power supply to the load device 300 is cut off. The voltage at which the control signal turns off is referred to as the GND level. The GND level voltage may refer to the potential that serves as the operating reference within a circuit, and may be usually designed as 0V. However, this reference potential is not necessarily connected to ground, and it also has the meaning of being a “virtual reference point” to ensure operational stability within the circuit.

FIG. 2B is a diagram illustrating an example of the processing of the semiconductor switch device 100 according to one or more embodiments, and is a diagram for explaining operation at the time of a power short. As in the case of FIG. 2A, when the control signal from the controller 130 is turned on, the drive signal of the driver 120 is turned on (time T3). As a result, the main switch 110 is turned on, and the output voltage of the output terminal becomes the power supply voltage VB.

Suppose then that a power short has occurred at the timing under “Power short occurrence” shown in FIG. 2B. In this case, for example, when the control signal from the controller 130 is turned off (GND level), the drive signal of the driver 120 is turned off (GND level) (time T4). However, due to a power short, power continues to be supplied even if the main switch 110 is turned off, and the output voltage of the output terminal does not drop to the GND level.

(Power short detection process in comparative examples) FIG. 3 is a diagram for explaining the process of power short detection in the semiconductor abnormality detection circuit disclosed in the patent document 1 as a comparative example. Under normal conditions, when the control signal of the power short detection is turned on at time T5, the drive signal is turned off (GND level). In this case, since the power supply to the load device is cut off, the output voltage of the output terminal is also at the GND level (off).

On the other hand, when the control signal of the power short detection is turned on at the time T7 during the power short, the drive signal is turned off (GND level). In this case, since the power supply to the load device is not interrupted by a power short, the output voltage of the output terminal does not decrease, and the power supply voltage VB is maintained. As a result, it may be possible to detect a power short in the semiconductor abnormality detection circuit of the comparative example.

However, in the load device, there is a device that requires constant energization during normal operation. Therefore, when applying the load device that requires constant energization in the semiconductor abnormality detection circuit of the comparative example, the semiconductor switch circuit may not be turned off, and a short circuit (power short) between the input and output may not be inspected.

The semiconductor switch device 100 according to one or more embodiments may realize the semiconductor switch device 100 capable of detecting a power short state without interrupting the power supply to the load side.

(Power short detection operation in the semiconductor switch device 100) Next, a method of detecting a power short on the input side and the output side in the semiconductor switch device 100 according to one or more embodiments is described below. FIG. 4 is a diagram for explaining power short detection operation according to one or more embodiments.

When the controller 130 outputs a signal that instructs the power short detection operation (turns on the control signal S2), the driver 120 outputs a signal that has a lower voltage than the normal ON signal, such that the main switch 110 is in a predetermined constant voltage regulation state (time T9). In one or more embodiments, the predetermined constant voltage regulation state is a state in which the main switch 110 is on and the output voltage (Vout) of the output terminal (OUT terminal) is lower than the power supply voltage VB.

Specifically, in the case of a power short detection operation, the driver 120 provides the gate of the main switch 110 with a voltage lower than the voltage given during normal operation. For example, a voltage lower than the voltage given during normal operation is a voltage substantially equal to the power supply voltage VB.

Further, the driver 120 operates the dummy load 160 to discharge the charge accumulated in the capacitance component present in the load device 300. As a result, a certain potential difference occurs between the VB terminal and the output terminal (time T9 to time T10).

However, when the VB terminal and the output terminal are in a power short (short circuit), even if the charge is discharged with a dummy load 160, the charge is immediately charged from the short circuit path, so that there is no potential difference between the VB terminal and the output terminal (time T11 to time T12, the dashed line is the expected value of the voltage at the output terminal). Therefore, the semiconductor switch device 100 may detect the presence or absence of a short circuit by measuring the potential between the VB terminal and the output terminal at this time.

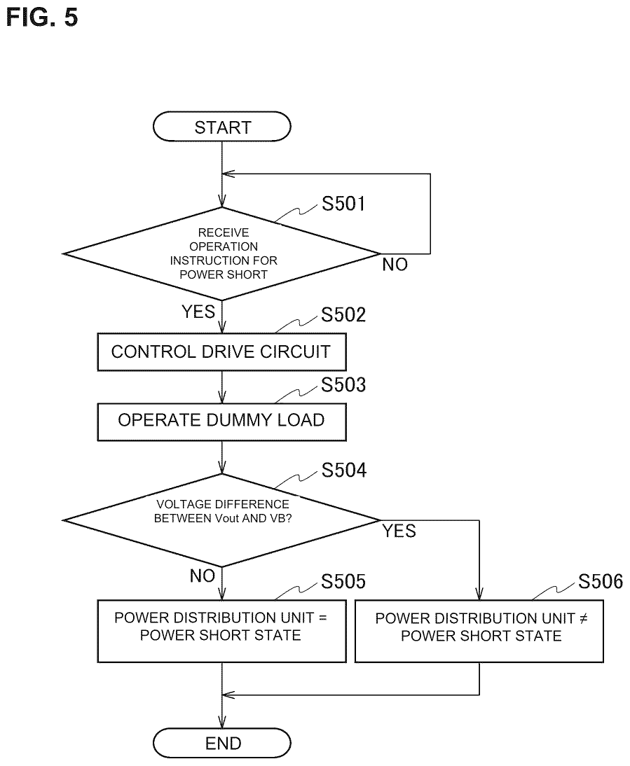

(Outline of processing flow of semiconductor switch device 100) Next, the flow of the power short detection operation in the semiconductor switch device 100 is shown using the flowchart shown in FIG. 5. The series of operations of the semiconductor switch device 100 shown in the flowchart of FIG. 5 starts when the semiconductor switch device 100 is activated, and the process ends when the work is completed. In the flowchart shown in FIG. 5, the operation is also terminated by power-off or an interruption at the end of the process. Further, in the description of the following flowchart, the same contents described in the description of the semiconductor switch device 100 described above is omitted or simplified.

In step S501, the controller 130 determines whether or not an operation instruction of a power short detection has been received. In step S501, when the controller 130 determines that it has received an operation instruction of a power short detection (step S501: YES), the process advances to step S502. On the other hand, in step S501, when the controller 130 determines that it has not received an operation instruction for the power short detection (step S501: NO), the process returns to step S501, and the process from step S501 is repeatedly performed. That is, the semiconductor switch device 100 performs normal operation until it receives an operation instruction for a power short detection.

In step S502, the controller 130 controls the driver 120. Specifically, the controller 130 turns on the control signal S2 and gives an operation instruction to the driver 120 for a power short detection. With the control instruction, the driver 120 outputs a signal that is lower in voltage than the normal ON signal such that the main switch 110 becomes in a predetermined constant voltage regulation state. Thereafter, the process continues to step S503.

In step S503, the driver 120 operates the dummy load 160 and discharges the charge accumulated in the capacitance component present in the load device 300. Thereafter, the process continues to step S504.

In step S504, the power short detector 150 determines whether or not the output voltage of the VOUT terminal (Vout) has a sufficient potential difference with respect to the power supply voltage VB of the VB terminal. In the present specification, the “sufficient potential difference” corresponds to the potential difference that may be detected by the power short detector 150. For example, the “sufficient potential difference” may be a potential corresponding to a voltage at a rate of 10% or more with respect to the voltage between the VB terminal and GND. Alternatively, the “sufficient potential difference” may be a potential difference of 1V or more with respect to the voltage between the VB terminal and GND.

In step S504, when the power short detector 150 determines that the output voltage of the VOUT terminal (Vout) has a sufficient potential difference with respect to the power supply voltage VB of the VB terminal (step S504: YES), the process advances to step S506. On the other hand, in step S504, when the power short detector 150 determines that the output voltage of the VOUT terminal (Vout) does not have a sufficient potential difference with respect to the power supply voltage VB of the VB terminal (step S504: NO), the process advances to step S505.

In step S505, the diagnostic circuit 140 determines that it is a power short state, and notifies the outside that the power distribution device 10 is in a power short state via the input/output interface 170 and the DIAG terminal. After that, the process is terminated.

In step S506, the diagnostic circuit 140 determines that it is a normal state rather than a power short state, and notifies the outside that the power distribution device 10 is in a normal state via the input/output interface 170 and the DIAG terminal. After that, the process is terminated. Note that the notification of the normal state by step S506 may not be in a mandatory form as long as the notification of the power short state of step S505 is implemented.

(Other embodiments) Although one or more embodiments have been described in detail with reference to the drawings, the technical scope is not limited by the contents described in the above embodiments. Further, the components described above include those that may be easily assumed by those skilled in the art and are substantially the same. Furthermore, the configurations described above may be appropriately combined. In addition, various omissions, substitutions, or modifications of the configuration may be made without departing from the gist of an embodiment or embodiments.

In one or more embodiments described above, the driver 120 showed a configuration in which the driver 120 is a signal with a voltage lower than the ON signal with respect to the main switch 110 in the case of a power short detection operation, and such that the main switch 110 is in a predetermined constant voltage regulation state. Specifically, the configuration was shown in which the driver 120 controls the main switch 110 to be in the above state by providing the substantial same voltage as the power supply voltage VB to the gate of the main switch 110. This configuration does not limit the configuration of the embodiment. For example, the driver 120 may drive the main switch 110 so that the voltage at the VOUT terminal is a predetermined ratio of the voltage between the VB terminal and GND. For example, a predetermined ratio may be set to a voltage of about 80% with respect to the voltage between the VB terminal and GND. Further, the predetermined ratio may be set to a voltage of 80% or more with respect to the voltage between the VB terminal and GND.

Further, the scope of an embodiment or embodiments may include a computer program (power short detection program) that causes a computer to execute a process (power short detection method) in the semiconductor switch device 100 described above, and a computer-readable recording medium that records the program. Here, the type of computer-readable recording medium is arbitrary. Further, the computer program is not limited to what is recorded on the above-described recording medium, and may be transmitted via a telecommunication line, a wireless or wired communication line, a network represented by the Internet, or the like.

Hereinafter, a semiconductor switch device 100, the power distribution device 10, and the power short detection method according to one or more embodiments are described.

The semiconductor switch device 100 according to a first embodiment is the semiconductor switch device 100 provided in the power distribution device and protects the power distribution device in the event of an abnormality. The semiconductor switch device 100 includes a main switch 110 that controls the on and off of power supplied from the power supply terminal electrically connected to the power supply 200 to the output terminal electrically connected to the load device 300. Further, the semiconductor switch device 100 includes the driver 120 that provides a lower voltage to the main switch 110 than in normal operation so that the main switch 110 is in a predetermined constant voltage regulation state in the case of a power short detection operation. Further, the semiconductor switch device 100 includes the controller 130 that gives instructions for normal operation or power short detection operation to the driver 120. Further, the semiconductor switch device 100 includes the power short detector 150 that detects whether or not the output voltage of the output terminal has a sufficient potential difference with respect to the power supply voltage of the power supply terminal in the case of a power short detection operation. Further, the semiconductor switch device 100 includes the diagnostic circuit 140 which diagnoses that it is in a power short state when it is detected that the output voltage does not have a sufficient potential difference with respect to the power supply voltage in the case of a power short detection operation, and outputs the diagnosis result to the outside.

This configuration may allow the semiconductor switch device 100 to detect power short without interrupting the power supply to the load side, because the semiconductor switch device 100 performs power short detection while keeping the main switch 110 in a constant voltage regulation state that is in an ON state.

The driver 120 of the semiconductor switch device 100 according to a second embodiment may provide a voltage of the same value as the power supply voltage of the power supply terminal to the gate of the main switch 110 in the case of a power short detection operation.

This configuration may enable the semiconductor switch device 100 to appropriately keep the main switch 110 in a constant voltage regulation state that is in the ON state in the implementation of power short detection.

The driver 120 of the semiconductor switch device 100 according to a third embodiment may drive the main switch 110 so that the output voltage is lower than the voltage between the power supply voltage and GND in the case of a power short detection operation.

This configuration may allow the semiconductor switch device 100 to detect power short without interrupting the power supply to the load side, because the semiconductor switch device 100 performs power short detection while the main switch 110 is turned on.

The driver 120 of the semiconductor switch device 100 according to a fourth embodiment may drive the main switch 110 so that the output voltage is set to 80% or more of the voltage between the power supply voltage and GND in the case of a power short detection operation.

With this configuration, the semiconductor switch device 100 may perform power short detection while keeping the main switch 110 on more accurately, enabling detection of power short without interrupting the power supply to the load side.

The semiconductor switch device 100 according to a fifth embodiment may further include a dummy load 160 electrically connected to the output terminal. Further, in the case of a power short detection operation, the power short detector 150 may operate a dummy load and discharge the charge accumulated in the capacitance component present in the load device 300.

With this configuration, the semiconductor switch device 100 may perform more accurate power short detection by more reliably discharging the charge accumulated in the capacitance component present in the load device 300.

The power distribution device 10 according to a sixth embodiment may include the semiconductor switch device 100, the power supply 200 electrically connected to the power supply terminal of the semiconductor switch device 100, and the load device 300 electrically connected to the output terminal of the semiconductor switch device 100.

This configuration may allow the power distribution device 10 to detect power short without interrupting the power supply to the load side, because the semiconductor switch device 100 performs power short detection while keeping the main switch 110 in a constant voltage regulation state that is in an ON state.

The power short detection method according to a seventh embodiment is a power short detection method performed in the semiconductor switch device 100 equipped with a main switch 110 that controls the on/off of power supplied from the power supply terminal electrically connected to the power supply 200 to the output terminal electrically connected to the load device 300. The power short detection method is a power short detection method for detecting a power short between the power supply terminal and the output terminal. In the power short detection method, the main switch 110 is given a voltage lower than that in the case of normal operation so that the main switch 110 is in a predetermined constant voltage regulation state in the case of a power short detection operation. Further, in the case of a power short detection operation, the power short detection method detects whether or not the output voltage of the output terminal has a sufficient potential difference with respect to the power supply voltage of the power supply terminal. Furthermore, in the case of the power short detection operation, when it is detected that the output voltage does not have a sufficient potential difference with respect to the power supply voltage, the power short detection method diagnoses that it is in a power short state, and outputs the diagnosis result to the outside.

This configuration with the power short detection method may make it possible to detect power short without interrupting the power supply to the load side for performing power short detection while keeping the main switch 110 in a constant voltage regulation state that is in the ON state.

In the related art, there is a device in the load device that requires constant energization during normal times. Therefore, when the load device that requires constant energization is applied in the semiconductor abnormality detection circuit disclosed in the patent document 1, it may not be turned off, and a short circuit (power short) between the input and output may not be inspected.

According to the semiconductor switch device, power distribution device, and power short detection method according to one or more embodiments, it may be possible to detect a power short condition without interrupting the power supply to the load side.

1. A semiconductor switch device that protects a circuit in case of abnormality comprising:
a main switch that switches power supplied from a power supply terminal electrically connected to a power supply to an output terminal electrically connected to a load device;
a driver that outputs a voltage lower than that of normal operation to the main switch so that the main switch is in a constant voltage regulation state in case of a power short detection operation of the driver;
a controller that controls a normal operation or a power short detection operation of the driver;
a power short detector that detects if an output voltage of an output terminal has a sufficient potential difference with respect to a power supply voltage of the power supply terminal in the case of the power short detection operation; and
a diagnostic circuit that diagnoses the power short and outputs a diagnostic result in response to detecting that the output voltage does not have a sufficient potential difference with respect to the power supply voltage in the case of the power short detection operation of the driver.

2. The semiconductor switch device according to claim 1, wherein
the driver outputs a voltage substantially equal to the power supply voltage of the power supply terminal to a gate of the main switch in the case of the power short detection operation of the driver.

3. The semiconductor switch device according to claim 1, wherein
the driver drives the main switch so that the output voltage is lower than the voltage between the power supply voltage and a GND level in the case of the power short detection operation.

4. The semiconductor switch device according to claim 3, wherein
the driver drives the main switch so that the output voltage is set to a voltage of 80% or more with respect to the voltage between the power supply voltage and the GND level in the case of the power short detection operation of the driver.

5. The semiconductor switch device according to claim 1, further comprising a dummy load electrically connected to the output terminal, wherein
the power short detector operates the dummy load and discharges a charge accumulated in a capacitance in the load device in the case of the power short detection operation of the driver.

6. A power distribution device comprising:
a semiconductor switch device comprising:
a main switch that switches power supplied from a power supply terminal electrically connected to a power supply to an output terminal electrically connected to a load device;
a driver that outputs a voltage lower than that of normal operation to the main switch so that the main switch is in a constant voltage regulation state in a case of a power short detection operation of the driver;
a controller that controls a normal operation or a power short detection operation of the driver;
a power short detector that detects if an output voltage of an output terminal has a sufficient potential difference with respect to a power supply voltage of the power supply terminal in the case of the power short detection operation; and
a diagnostic circuit that diagnoses the power short and outputs a diagnostic result in response to detecting that the output voltage does not have a sufficient potential difference with respect to the power supply voltage in the case of the power short detection operation of the driver;
a power supply electrically connected to the power supply terminal of the semiconductor switch device; and
a load device electrically connected to the output terminal of the semiconductor switch device.

7. The power distribution device according to claim 6, wherein
the driver outputs a voltage substantially equal to the power supply voltage of the power supply terminal to a gate of the main switch in the case of the power short detection operation.

8. The power distribution device according to claim 6, wherein
the driver drives the main switch so that the output voltage is lower than the voltage between the power supply voltage and a GND level in the case of the power short detection operation.

9. The power distribution device according to claim 8, wherein
the driver drives the main switch so that the output voltage is set to a voltage of 80% or more with respect to the voltage between the power supply voltage and the GND level in the case of the power short detection operation.

10. The power distribution device according to claim 6, wherein, the semiconductor switch device further comprises a dummy load electrically connected to the output terminal, wherein
the power short detector operates the dummy load and discharges a charge accumulated in a capacitance in the load device in the case of the power short detection operation.

11. A power short detection method comprising:
receiving an instruction for a power short detection operation to detect a power short between a power supply terminal and an output terminal in a semiconductor switch device comprising a main switch that switches power supplied from the power supply terminal electrically connected to a power supply to the output terminal electrically connected to a load device;
outputting a voltage lower than that of normal operation to the main switch so that the main switch is in a predetermined constant voltage regulation state;
detecting whether an output voltage of the output terminal has a sufficient potential difference with respect to a power supply voltage of the power supply terminal; and
diagnosing the power short and outputting a diagnostic result in response to detecting that the output voltage does not have a sufficient potential difference with respect to the power supply voltage.

12. The power short detection method according to claim 11, wherein
outputting a voltage having a substantially equal to the power supply voltage of the power supply terminal to a gate of the main switch.

13. The power short detection method according to claim 11, wherein
driving the main switch so that the output voltage is lower than the voltage between the power supply voltage and a GND level.

14. The power short detection method according to claim 13, wherein driving the main switch so that the output voltage is set to a voltage of 80% or more with respect to the voltage between the power supply voltage and the GND level.

15. The power short detection method according to claim 11, further comprises operating a dummy load to discharge a charge accumulated in a capacitance in the load device.
